(19) United States
(12) Patent Application Publication
(10) Pub. No.: US 2026/0341076 A1
(43) Pub. Date: Oct. 29, 2026

(54) DETECTION DEVICE

(71) Applicant: Japan Display Inc., Tokyo (JP)

(72) Inventor: Ken OHARA, Tokyo (JP)

(21) Appl. No.: 19/654,792

(22) Filed: Apr. 22, 2026

(30) Foreign Application Priority Data
Apr. 24, 2025 (JP) 2025-072509

(51) Int. Cl. G06V 40/145; G06V 40/13

(52) U.S. Cl. CPC G06V 40/145; G06V 40/13

(57) ABSTRACT

According to an aspect, a detection device includes: a ring-shaped housing; a plurality of optical sensors and at least one light source that are provided on an inner peripheral surface side of the housing; and a detection circuit that is coupled to the optical sensors and configured to acquire a detection value from each of the optical sensors. Assuming a period in which the detection values are acquired from the optical sensors as a frame period, the light source is configured to repeatedly turn on and off for each of the frame periods, and a difference between a first detection value acquired when the light source is off and a second detection value acquired when the light source is on is acquired as detection data for each of the optical sensors in the adjacent frame periods.

### CROSS-REFERENCE TO RELATED APPLICATION

This application claims the benefit of priority from Japanese Patent Application No. 2025-072509 filed on Apr. 24, 2025, the entire contents of which are incorporated herein by reference.

### BACKGROUND

### 1. Technical Field

What is disclosed herein relates to a detection device.

### 2. Description of the Related Art

Optical sensors capable of detecting fingerprint patterns, vein patterns, and the like are known (for example, Japanese Patent Application Laid-open Publication No. 2023-012380 and Japanese Patent Application Laid-open Publication No. 2023-125171). Such optical sensors are incorporated into wearable devices, such as smartwatches, wristwatches, and wristbands, and used to acquire biometric information such as pulse waves.

A detection device using such an optical sensor may receive not only light emitted from a light source and reflected by or transmitted through an object to be detected but also external light. The external light may reduce contrast of images.

For the foregoing reasons, there is a need for a detection device capable of inhibiting the reduction in contrast of images.

### SUMMARY

According to an aspect, a detection device includes: a ring-shaped housing; a plurality of optical sensors and at least one light source that are provided on an inner peripheral surface side of the housing; and a detection circuit that is coupled to the optical sensors and configured to acquire a detection value from each of the optical sensors. Assuming a period in which the detection values are acquired from the optical sensors as a frame period, the light source is configured to repeatedly turn on and off for each of the frame periods, and a difference between a first detection value acquired when the light source is off and a second detection value acquired when the light source is on is acquired as detection data for each of the optical sensors in the adjacent frame periods.

### BRIEF DESCRIPTION OF THE DRAWINGS

FIG. 1 is a schematic view illustrating a detection device according to an embodiment of the present invention;

FIG. 2 is a sectional view taken along II-II′ in FIG. 1;

FIG. 3 is a sectional view taken along III-III′ in FIG. 2;

FIG. 4 is a sectional view illustrating a schematic sectional configuration of the detection device according to the embodiment;

FIG. 5 is a plan view illustrating the detection device according to the embodiment;

FIG. 6 is a block diagram illustrating a configuration example of the detection device according to the embodiment;

FIG. 7 is a circuit diagram illustrating the detection device;

FIG. 8 is a flowchart illustrating an example of a detection data generation process of the detection device according to the embodiment; and

FIG. 9 is a timing waveform diagram illustrating the example of the detection data generation process of the detection device according to the embodiment.

### DETAILED DESCRIPTION

The following describes a mode (embodiment) for carrying out the present disclosure in detail with reference to the drawings. The present disclosure is not limited to the description of the embodiment given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In the present disclosure, in expressing an aspect of disposing another structure on or above a certain structure, a case of simply expressing “on” includes both a case of disposing the other structure immediately on the certain structure so as to contact the certain structure and a case of disposing the other structure above the certain structure with still another structure interposed therebetween, unless otherwise specified.

### Embodiment

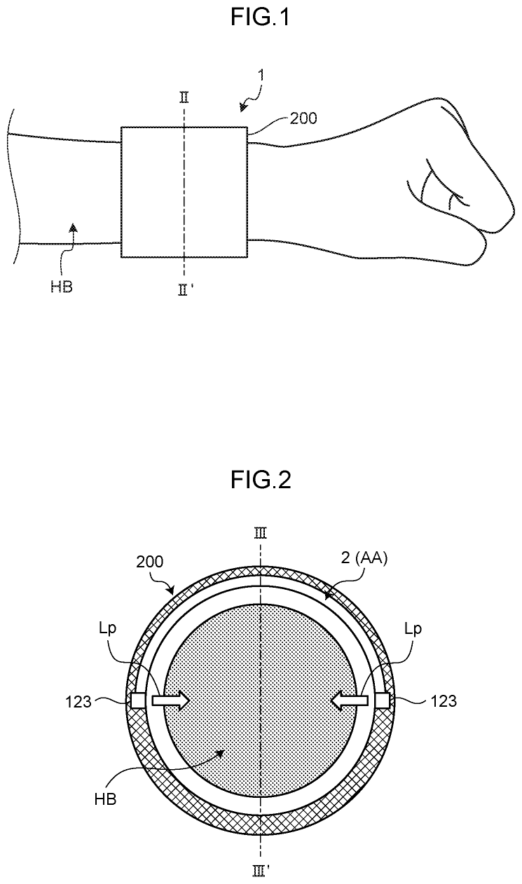

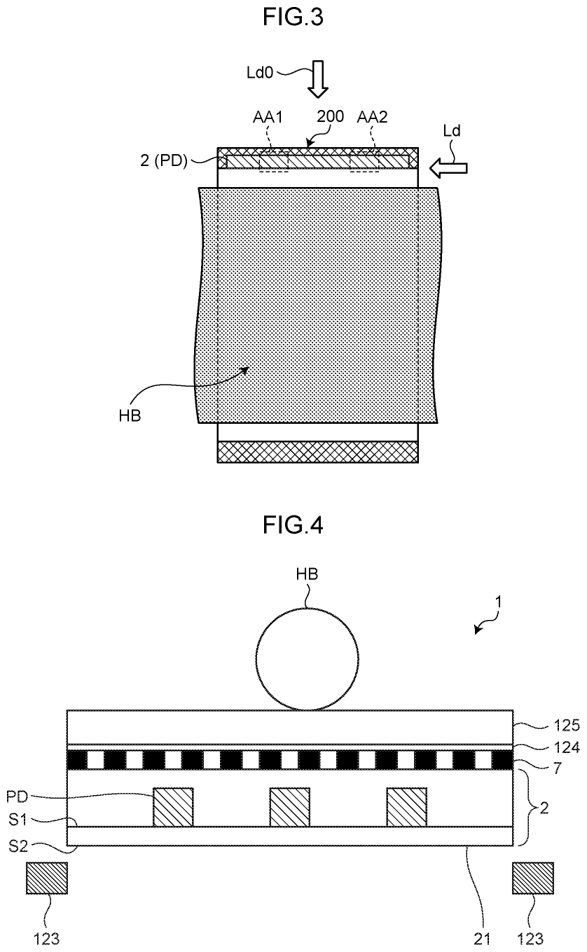

FIG. 1 is a schematic view illustrating a detection device according to an embodiment of the present invention. FIG. 2 is a sectional view taken along II-II′ in FIG. 1. FIG. 3 is a sectional view taken along III-III′ in FIG. 2. As illustrated in FIG. 1, a detection device 1 is a ring-shaped wearable device such as a smartwatch, a wristwatch, or a wristband, and is worn on a human body HB as an object to be measured. The detection device 1 includes a ring-shaped housing 200. The ring-shaped housing 200 is a wristband that is worn on a wrist. However, the ring-shaped housing 200 is not limited thereto, and may be a finger ring worn on a finger, or may be worn on an arm, a leg, or other parts of the human body HB. The ring-shaped housing 200 may be a bracelet that has a diameter clearly larger than the diameter of the human body HB such that a gap is provided between the ring-shaped housing 200 and the human body HB.

As illustrated in FIG. 2, the detection device 1 includes the housing 200, an array substrate 2 having a detection area AA, and a plurality of light sources 123. The array substrate 2 and the light sources 123 are provided on an inner peripheral surface side of the housing 200. A plurality of optical sensors PD (refer to FIG. 4) are arranged in the detection area AA of the array substrate 2. That is, the optical sensors PD and the light sources 123 are provided on the inner peripheral surface side of the housing 200.

The detection area AA of the array substrate 2 is arranged along the peripheral direction of the housing 200. The light sources 123 are respectively arranged at both ends in the peripheral direction of the detection area AA. In the example illustrated in FIG. 2, the detection device 1 includes two light sources 123, and the human body HB is placed between the two light sources 123. For example, inorganic light-emitting diodes (LEDs), organic electroluminescent (EL) diodes (organic light-emitting diodes (OLEDs)), or the like are used as the light sources 123. The light sources 123 emit light that has a predetermined wavelength depending on the object to be measured.

Light Lp emitted from the two light sources 123 passes through the human body HB or is reflected in the human body HB, and enters the optical sensors PD in the detection area AA. Thus, the detection device 1 can detect information on a living body in the human body HB or the like. Examples of the information on the living body include, but are not limited to, pulse waves, pulsation, and a vascular image of the human body HB. That is, the detection device 1 may be configured as a vein detection device that detects a vascular pattern of veins or the like. The light emitted from the light sources 123 is set to have a wavelength (in visible light region to near-infrared light region) depending on a detection target. The light sources 123 are not limited to one type, and a plurality of types having different wavelengths may be provided.

The number of the light sources 123 is not limited to two, and at least one or more light sources 123 only need to be provided. Three or more light sources 123 may be provided. In this case, the light sources 123 may be arranged at both ends in the peripheral direction of the detection area AA, and in addition, at both ends in the tubular direction of the detection area AA of the array substrate 2, or on the opposite side of the detection area AA of the housing 200.

As illustrated in FIG. 3, the sectional shape of the housing 200 is hollow, and the array substrate 2 (optical sensors PD) and the light source 123 (not illustrated in FIG. 3) are accommodated in the housing 200. The array substrate 2 is accommodated in the housing 200, for example, by being formed into a ring shape and, in that state, filling a surrounding area thereof with a filling material in a mold to form the housing 200. The housing 200 is formed into a ring shape using, for example, a metal or a non-light-transmitting synthetic resin. That is, the housing 200 exhibits a non-light-transmitting property on the outer peripheral surface side thereof. However, the housing 200 may be configured as a combination of a plurality of members, such as a light-transmitting resin material and a metal material.

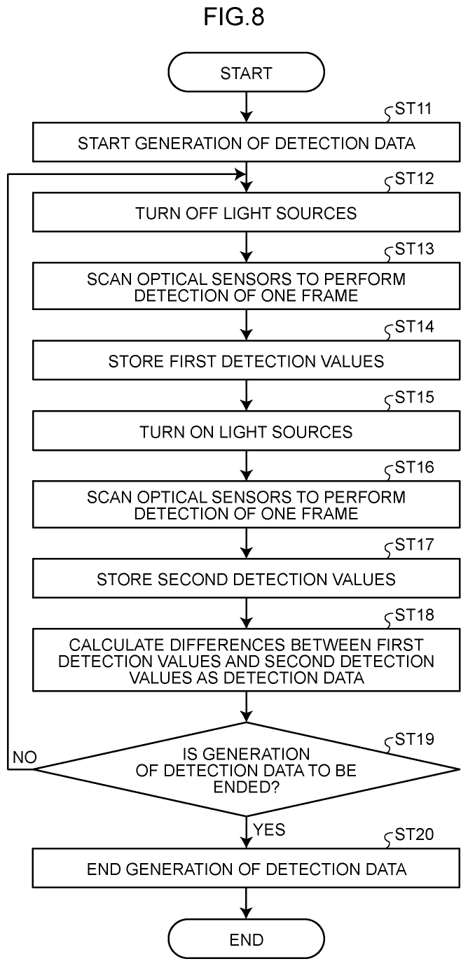

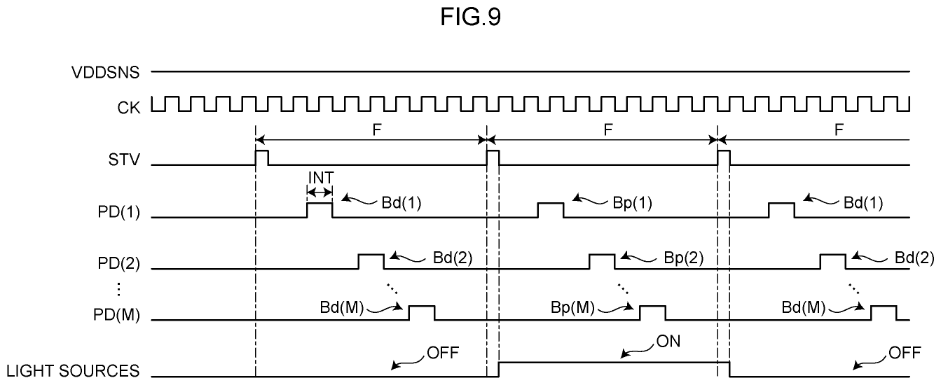

Since the outer peripheral surface side of the housing 200 exhibits a non-light-transmitting property, external light Ld0 from outside in the radial direction (upper side or lower side in FIG. 3) is blocked by the housing 200. However, the ring shaped housing 200 is the wristband that is worn on the wrist, and a certain gap is formed between the housing 200 and the wrist. Therefore, external light Ld may enter in the detection device 1 through the gap between the housing 200 and the wrist. The detection device 1 of the present embodiment, however, can inhibit reduction in contrast of an image even when the external light Ld enters therein. The generation of detection data in the detection device 1 of the present embodiment will be described later with reference to FIGS. 8 and 9.

FIG. 4 is a sectional view illustrating a schematic sectional configuration of the detection device according to the embodiment. In FIG. 4, for ease of viewing, the array substrate 2 is developed into a planar shape, and a part of the array substrate 2 is illustrated in a magnified manner. As illustrated in FIG. 4, the detection device 1 includes the array substrate 2, an optical filter layer 7, the light sources 123, an adhesive layer 124, and a cover member 125. The array substrate 2, the optical filter layer 7, the adhesive layer 124, and the cover member 125 are stacked in this order in a direction orthogonal to a first principal surface S1 of the array substrate 2.

The array substrate 2 is formed using a sensor base member 21 as a base. The array substrate 2 includes the optical sensors PD provided on the first principal surface S1 side of the sensor base member 21. Each of the optical sensors PD is, for example, an organic photodiode (OPD), and outputs an electrical signal corresponding to light emitted thereto. The optical sensor PD is not limited to the organic photodiode (OPD). The optical sensor PD may be, for example, a positive-intrinsic-negative (PIN) photodiode formed of an inorganic semiconductor material.

The optical filter layer 7 is disposed so as to face the optical sensors PD and is disposed between the optical sensors PD and an object to be detected, such as the human body HB. The optical filter layer 7 has a plurality of light guide paths and a light-blocking portion provided around the light guide paths. At least some of the light guide paths overlap the optical sensors PD. The light-blocking portion has higher optical absorbance than the light guide paths. The optical filter layer 7 is an optical element that transmits, toward the optical sensors PD, components traveling in a predetermined direction of light reflected by the object to be detected, such as the human body HB. The optical filter layer 7 is also called collimating apertures or a collimator. The optical filter layer 7 is not limited to a configuration in which the light guide paths are formed in a columnar shape, and various configurations can be applied.

The cover member 125 is a member for protecting the array substrate 2 and the optical filter layer 7 and covers the array substrate 2 and the optical filter layer 7. The cover member 125 is, for example, a glass substrate. The cover member 125 is not limited to the glass substrate, and may be a resin substrate or the like, or may be formed of a plurality of layers of these substrates. The cover member 125 is bonded to a surface of the optical filter layer 7 with the adhesive layer 124 interposed therebetween. However, the adhesive layer 124 may be absent. Alternatively, the cover member 125 need not be provided. In this case, a protective layer such as an insulating film is provided on the surface of the array substrate 2 and the optical filter layer 7, and the human body HB contacts the protective layer of the detection device 1.

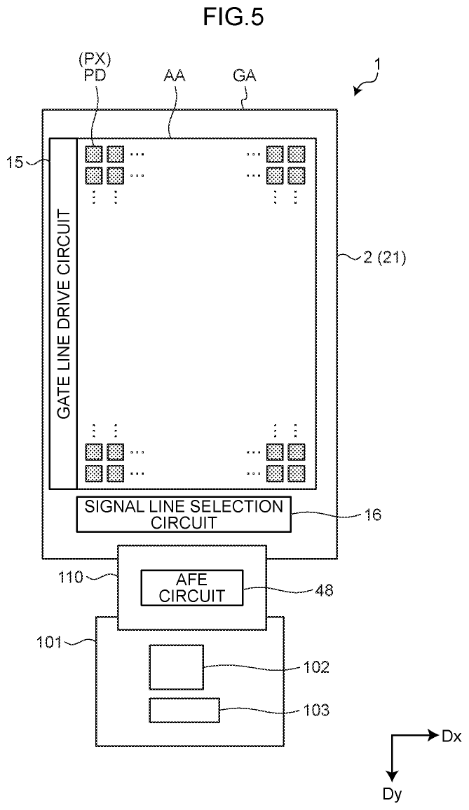

FIG. 5 is a plan view illustrating the detection device according to the embodiment. FIG. 5 schematically illustrates the sensor base member 21 (array substrate 2) developed into a planar shape. As illustrated in FIG. 5, the detection device 1 includes the sensor base member 21 (array substrate 2), a gate line drive circuit 15, a signal line selection circuit 16, a detection circuit 48, a control circuit 102, and a power supply circuit 103.

The sensor base member 21 is electrically coupled to a control substrate 101 through a wiring substrate 110. The wiring substrate 110 is, for example, a flexible printed circuit board or a rigid circuit board. The wiring substrate 110 is provided with the detection circuit 48. The detection circuit 48 is an analog front-end (AFE) circuit, for example.

The control substrate 101 is provided with the control circuit 102 and the power supply circuit 103. The control circuit 102 is, for example, a control integrated circuit (IC) that outputs logic control signals. The control circuit 102 may be, for example, a programmable logic device (PLD) such as a field-programmable gate array (FPGA). The control circuit 102 supplies control signals to the gate line drive circuit 15 and the signal line selection circuit 16 to control detection operations of the optical sensors PD (sensor pixels PX). The control circuit 102 also supplies control signals to the light sources 123 to control lighting or non-lighting of the light sources 123.

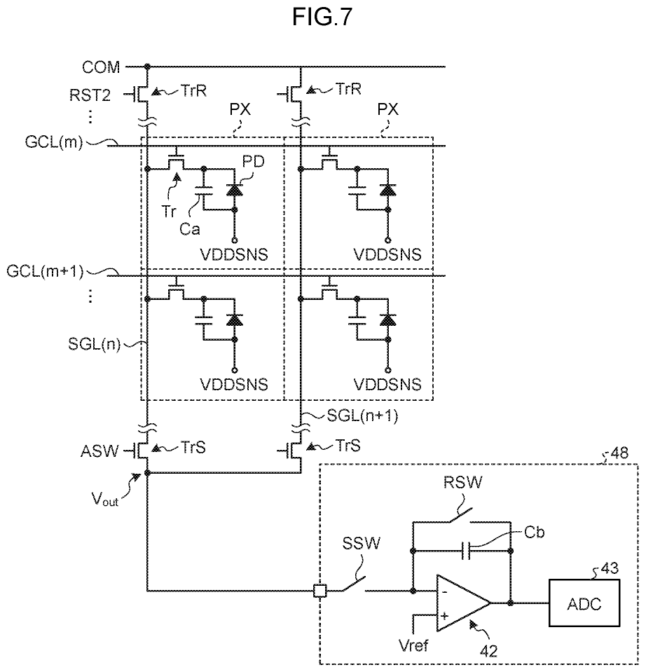

The power supply circuit 103 supplies voltage signals such as a sensor power supply potential VDDSNS (refer to FIG. 7) to the optical sensors PD (sensor pixels PX), the gate line drive circuit 15, and the signal line selection circuit 16. The power supply circuit 103 also supplies a power supply voltage to the light sources 123.

The gate line drive circuit 15 and the signal line selection circuit 16 are provided in a peripheral area GA outside the detection area AA. Specifically, the gate line drive circuit 15 is provided in an area extending along a second direction Dy in the peripheral area GA. The signal line selection circuit 16 is provided in an area extending along a first direction Dx in the peripheral area GA (between the detection area AA and the detection circuit 48 in the example illustrated in FIG. 5).

The first direction Dx is one direction in a plane parallel to the sensor base member 21. The second direction Dy is one direction in the plane parallel to the sensor base member 21 and is a direction orthogonal to the first direction Dx. The second direction Dy may non-orthogonally intersect the first direction Dx. In the present disclosure, the term “plan view” refers to a positional relation as viewed from a direction orthogonal to the sensor base member 21.

The second direction Dy in FIG. 5 corresponds to the peripheral direction when incorporated into the ring-shaped housing 200 (refer to FIG. 2). The first direction Dx in FIG. 5 corresponds to a direction orthogonal to the peripheral direction when the detection device is incorporated into the ring-shaped housing 200. The direction orthogonal to the sensor base member 21 corresponds to the radial direction when the detection device is incorporated into the ring-shaped housing 200.

The optical sensors PD (sensor pixels PX) are arranged in a matrix having a row-column configuration in the detection area AA. That is, the optical sensors PD (sensor pixels PX) are arranged in a planar configuration along the second direction Dy and the first direction Dx. When the array substrate 2 is incorporated into the ring-shaped housing 200 (refer to FIG. 2), the optical sensors PD (sensor pixels PX) are arranged in a planar configuration along the peripheral direction of the housing 200 and the direction orthogonal to the peripheral direction of the housing 200.

The arrangement of the optical sensors PD (sensor pixels PX) illustrated in FIG. 5 is, however, only an example and is not limited to this example. The optical sensors PD (sensor pixels PX) need only be arranged such that at least two are aligned along the second direction Dy (peripheral direction of the housing 200). Alternatively, the optical sensors PD (sensor pixels PX) need only be arranged such that at least two are aligned along the first direction Dx (direction orthogonal to the peripheral direction of the housing 200).

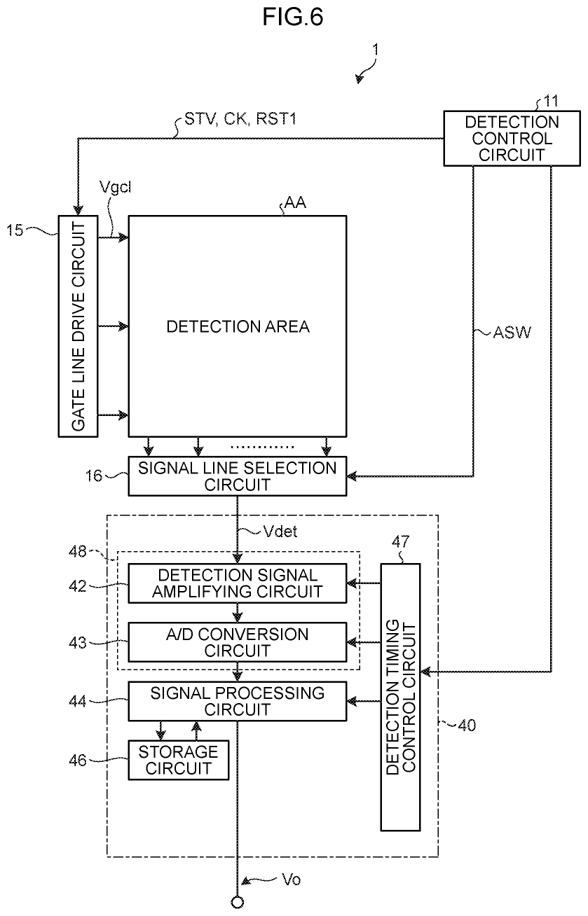

FIG. 6 is a block diagram illustrating a configuration example of the detection device according to the embodiment. As illustrated in FIG. 6, the detection device 1 further includes a detection control circuit 11 and a detector (detection circuitry) 40. The detection control circuit 11 is included in the control circuit 102, for example. The detector 40 includes the detection circuit 48.

Each of the optical sensors PD (sensor pixels PX) outputs the electrical signal corresponding to the light emitted thereto as a detection signal Vdet to the signal line selection circuit 16. Each of the optical sensors PD (sensor pixels PX) performs detection in response to a gate drive signal Vgcl supplied from the gate line drive circuit 15.

The detection control circuit 11 is a circuit that supplies respective control signals to the gate line drive circuit 15, the signal line selection circuit 16, and the detector 40 to control operations of these circuits. The detection control circuit 11 supplies various control signals such as a start signal STV, a clock signal CK, and a reset signal RST1 to the gate line drive circuit 15. The detection control circuit 11 also supplies various control signals such as a selection signal ASW to the signal line selection circuit 16. The detection control circuit 11 also supplies various control signals to the light sources 123 to control the lighting and the non-lighting of the light sources 123.

The gate line drive circuit 15 is a circuit that drives a plurality of gate lines GCL (refer to FIG. 7) based on various control signals. The gate line drive circuit 15 sequentially or simultaneously selects the gate lines GCL and supplies the gate drive signal Vgcl to the selected gate lines GCL. Through this operation, the gate line drive circuit 15 selects the optical sensors PD coupled to the gate lines GCL.

The signal line selection circuit 16 is a switch circuit that sequentially or simultaneously selects a plurality of signal lines SGL (refer to FIG. 7). The signal line selection circuit 16 is a multiplexer, for example. The signal line selection circuit 16 electrically couples the selected signal lines SGL to the detection circuit 48 based on the selection signal ASW supplied from the detection control circuit 11. Through this operation, the signal line selection circuit 16 outputs the detection signals Vdet of the optical sensors PD to the detection circuit 48.

The detector 40 includes the detection circuit 48, a signal processing circuit 44, a storage circuit 46, and a detection timing control circuit 47. The detection timing control circuit 47 controls the detection circuit 48 and the signal processing circuit 44 to operate them synchronously based on a control signal supplied from the detection control circuit 11.

The detection circuit 48 is a signal processing circuit having functions of at least a detection signal amplifying circuit 42 and an analog-to-digital (A/D) conversion circuit 43. The detection signal amplifying circuit 42 amplifies the detection signals Vdet. The A/D conversion circuit 43 converts the analog signals output from the detection signal amplifying circuit 42 into digital signals at a predetermined sampling period.

In the present disclosure, the control circuit 102 includes the signal processing circuit 44 and the storage circuit 46.

The signal processing circuit 44 is a logic circuit that detects predetermined physical quantities received by the detection area AA based on output signals of the detection circuit 48. The signal processing circuit 44 can detect the information on the living body based on the signals from the detection circuit 48 when the object to be detected, such as the finger or the arm, is in contact with or in proximity to a detection surface. Examples of the information on the living body include, but are not limited to, the vascular image, the pulse waves, the pulsation, and a blood oxygen level of the finger or the palm.

The storage circuit 46 temporarily stores therein the signals processed by the signal processing circuit 44. The storage circuit 46 may, in an aspect, include a random-access memory (RAM), a read-only memory (ROM), an electrically erasable programmable read-only memory (EEPROM), and the like. The storage circuit 46 may be a register circuit or the like.

The following describes a circuit configuration example of the detection device 1. FIG. 7 is a circuit diagram illustrating the detection device. As illustrated in FIG. 7, the sensor pixels PX that include the optical sensors PD are arranged in a matrix having a row-column configuration. Each of the sensor pixels PX includes the optical sensor PD, a capacitive component Ca, and a transistor Tr.

The capacitive component Ca is capacitance (sensor capacitance) generated in the optical sensor PD and is equivalently coupled in parallel to the optical sensor PD.

The gate lines GCL each extend in the first direction Dx and are arranged in the second direction Dy. Each of the gate lines GCL is coupled to the gate line drive circuit 15. The signal lines SGL each extend in the second direction Dy and are arranged in the first direction Dx. Each of the signal lines SGL is coupled to the signal line selection circuit 16.

FIG. 7 illustrates two gate lines GCL(m) and GCL(m+1) arranged in the second direction Dy among the gate lines GCL. FIG. 7 also illustrates two signal lines SGL(n) and SGL(n+1) arranged in the first direction Dx among the signal lines SGL. The sensor pixel PX is an area surrounded by the adjacent gate lines GCL and the adjacent signal lines SGL.

The transistor Tr is provided correspondingly to the optical sensor PD. The transistor Tr is configured with a thin-film transistor, and in this example, configured with an n-channel metal-oxide-semiconductor (MOS) thin-film transistor (TFT).

The gates of the transistors Tr belonging to the sensor pixels PX arranged in the first direction Dx are coupled to the gate line GCL. The sources of the transistors Tr belonging to the sensor pixels PX arranged in the second direction Dy are coupled to the signal line SGL. The drain of the transistor Tr is coupled to the cathode of the optical sensor PD and the capacitive component Ca.

The anode of the optical sensor PD is supplied with the sensor power supply potential VDDSNS from the power supply circuit 103. The cathode of the optical sensor PD is supplied with a reference signal COM that serves as an initial potential of the signal line SGL and the capacitive component Ca from the power supply circuit 103.

When each of the sensor pixels PX in the detection area AA is irradiated with light, a current corresponding to a light intensity flows through the optical sensor PD. As a result, an electric charge corresponding to the light intensity is stored in the capacitive component Ca. Turning on the transistor Tr causes a current corresponding to the electric charge stored in the capacitive component Ca to flow through the signal line SGL. The signal line SGL is coupled to the detection circuit 48 via a coupling transistor TrS of the signal line selection circuit 16. The detection circuit 48 is coupled to the optical sensors PD via the signal line SGL and the signal line selection circuit 16 and acquires a detection value from each of the optical sensors PD. Thus, the detection device 1 can detect a signal corresponding to the light intensity irradiating the optical sensor PD in each of the sensor pixels PX.

During a readout period INT (refer to FIG. 9), a switch SSW is turned on to couple the detection circuit 48 to the signal line SGL. The detection signal amplifying circuit 42 of the detection circuit 48 converts a current supplied from the signal line SGL into a voltage and amplifies the voltage. A reference potential (Vref) having a fixed potential is supplied to a non-inverting input part (+) of the detection signal amplifying circuit 42, and the signal line SGL is coupled to the inverting input terminal (−) of the detection signal amplifying circuit 42. In the embodiment, the same signal as the reference signal COM is supplied as the reference potential (Vref) voltage. The detection signal amplifying circuit 42 of the detection circuit 48 includes a capacitive element Cb and a reset switch RSW. During a reset period (not illustrated), the reset switch RSW is turned on to reset the electric charge of the capacitive element Cb.

The A/D conversion circuit 43 performs signal processing of the output voltage output from the detection signal amplifying circuit 42 and outputs a detection value corresponding to a photocurrent from the optical sensor PD. As a result, the detection value acquired by each of the optical sensors PD is stored in the storage circuit 46 (refer to FIG. 6).

FIGS. 5 to 7 illustrate a configuration in which the optical sensors PD are scanned by what is called an active matrix method. The configuration in FIGS. 5 to 7 is merely an example, and the method for scanning the optical sensors PD is not limited to this configuration. For example, the control circuit 102 may individually drive each of the optical sensors PD. In this case, the optical sensors PD may each be individually coupled to the power supply circuit 103 and the detection circuit 48 via wiring or the like.

The following describes a method for generating the detection data in the detection device 1 according to the present embodiment with reference to FIGS. 8 and 9. FIG. 8 is a flowchart illustrating an example of a detection data generation process of the detection device according to the embodiment. FIG. 9 is a timing waveform diagram illustrating the example of the detection data generation process of the detection device according to the embodiment.

As illustrated in FIG. 8, the detection device 1 starts the generation of the detection data (Step ST11). The time when the generation of the detection data starts is, for example, the time when the power supply of the detection device 1 is turned on, that is, the time when the power supply circuit 103 is turned on. The time when the generation of the detection data starts is, however, not limited to this time, and may be the time when a user wearing the ring-shaped housing 200 operates a switch, a button, or the like to enter a command to start the generation of the detection data to the control circuit 102.

The control circuit 102 (detection control circuit 11) first turns off the light sources 123 (Step ST12).

The control circuit 102 scans the optical sensors PD to perform detection of one frame (Step ST13).

As illustrated in FIG. 9, the control circuit 102 (detection control circuit 11) outputs a start signal STV at a high-level voltage to start the detection of one frame. In FIG. 9, optical sensors PD(1) represent the optical sensors PD in the first row of the optical sensors PD, that is, the optical sensors PD coupled to a gate line GCL(1) in the first row. Optical sensors PD(2) are the optical sensors PD in the second row, and optical sensors PD(M) are the optical sensors PD in the last row. A frame period F illustrated in FIG. 9 is a period required to sequentially scan the optical sensors PD in one frame from the optical sensors PD(1) in the first row to the optical sensors PD(M) in the last row and acquire the detection values from the respective optical sensors PD.

The operations in readout periods INT of the respective optical sensors PD(1), PD(2), . . . , PD(M) are sequentially performed in a time-division manner. The detection circuit 48 thereby acquires first detection values Bd(1), Bd(2), . . . , Bd(M) output from the optical sensors PD(1), PD(2), . . . , PD(M), respectively. That is, the first detection values Bd are the detection values output from the optical sensors PD when the light sources 123 are off, and are also called baseline data.

In the following description, the optical sensors PD(1), PD(2), . . . , PD(M) will be simply referred to as “optical sensors PD” when they need not be distinguished from one another. The first detection values Bd(1), Bd(2), . . . , Bd(M) will be simply referred to as “first detection values Bd” when they need not be distinguished from one another. Second detection values Bp(1), Bp(2), . . . , Bp(M) to be described later will be simply referred to as “second detection values Bp” when they need not be distinguished from one another.

The detection circuit 48 then outputs the acquired first detection values Bd to the storage circuit 46 (refer to FIG. 6). The storage circuit 46 stores the received first detection values Bd (step ST14). At Steps ST13 and ST14, the detection circuit 48 acquires the first detection values Bd of the optical sensors PD (sensor pixels PX), and the storage circuit 46 stores therein the first detection values Bd of the optical sensors PD (sensor pixels PX).

Then, the control circuit 102 (detection control circuit 11) turns on the light sources 123 (Step ST15).

The control circuit 102 scans the optical sensors PD to perform the detection of one frame (Step ST16).

As illustrated in FIG. 9, the control circuit 102 (detection control circuit 11) outputs the start signal STV at the high-level voltage, the light source 123 turns on, and detection of one frame starts. In the same way as the detection of one frame when the light sources 123 are off described above, the operations in the readout periods INT of the respective optical sensors PD(1), PD(2), . . . , PD(M) are sequentially performed in a time-division manner. The detection circuit 48 thereby acquires the second detection values Bp(1), Bp(2), . . . , Bp(M) output from the optical sensors PD(1), PD(2), . . . , PD(M). That is, the second detection values Bp are the detection values output from the optical sensors PD when the light sources 123 are on.

The detection circuit 48 then outputs the acquired second detection values Bp to the storage circuit 46 (refer to FIG. 6). The storage circuit 46 stores therein the received second detection values Bp (Step ST17). At Steps ST16 and ST17, the detection circuit 48 acquires the second detection values Bp of the optical sensors PD (sensor pixels PX), and the storage circuit 46 stores therein the second detection values Bp of the optical sensors PD (sensor pixels PX).

The signal processing circuit 44 receives the first detection values Bd and the second detection values Bp acquired by the detection circuit 48 at Steps ST13 and ST16 from the storage circuit 46. The signal processing circuit 44 calculates the differences between the first detection values Bd and the second detection values Bp as detection data C (Step ST18).

The control circuit 102 determines whether to end the generation of the detection data (Step ST19). The time when the generation of the detection data ends is, for example, the time when the power supply of the detection device 1 is turned off, that is, the time when the power supply circuit 103 is turned off. The time when the generation of the detection data ends is, however, not limited to this time, and may be the time when the user wearing the ring-shaped housing 200 operates a switch, a button, or the like to enter a command to end the generation of the detection data to the control circuit 102.

If the generation of the detection data is not to be ended (No at Step ST19), the control circuit 102 returns the process to Step ST12 to repeat the generation of the detection data. That is, the detection device 1 repeatedly performs Steps ST12 to ST18 in a plurality of the frame periods F from the start to the end of the measurement of the optical sensors PD, or in the multiple frame periods F from the power on to the power off of the detection device 1. The light sources 123 are turned on and off repeatedly for each of the frame periods F. In other words, the light sources 123 are switched between on and off between the adjacent frame periods F. The detection device 1 performs the generation of the detection data C in each of the adjacent frame periods F.

If the generation of the detection data is to end (Yes at Step ST19), the control circuit 102 ends the scanning of the optical sensors PD, turns off the light sources 123, and ends the generation of the detection data (Step ST20).

As described above, in the detection device 1 of the present embodiment, the light sources 123 are turned on and off repeatedly for each of the frame periods F. The differences between the first detection values Bd acquired when the light sources 123 are off and the second detection values Bp acquired when the light sources 123 are on in the respective optical sensors PD in the adjacent frame periods F are the detection data C.

In other words, each time the second detection values Bp are acquired from the optical sensors PD when the light sources 123 are on, the detection device 1 of the present embodiment acquires the first detection values Bd that are baseline data when the light sources 123 are off in the adjacent frame periods F. This operation allows the first detection values Bd and the second detection values Bp corresponding to the external light Ld to be acquired for each pair of the adjacent frame periods F even when the light intensity of the external light Ld varies over time or when the relative position (gap) between the human body HB and the housing 200 (detection area AA) deviates. Therefore, the detection device 1 of the present embodiment can inhibit the reduction in contrast due to variations of the external light Ld.

In more detail, detection data C1 and C2 is calculated for two different detection areas AA1 and AA2 (refer to FIG. 3), respectively, of the detection area AA. The detection data C1 of the detection area AA1 is expressed by Expression (1) given below.

C1=D×Lphoto(ti)−D×Ldark(ti)=D×(La+Ld(ti))−D×(Ld(ti)+Ldark)≈D×La (1)

D×Ldark(ti) corresponds to the first detection values Bd acquired when the light sources 123 are off, and D×Lphoto(ti) corresponds to the second detection values Bp obtained when the light sources 123 are on. D is a predetermined constant.

Ldark(ti) in the first detection values Bd corresponds to the light entering the detection area AA1 when the light sources 123 are off, and includes external light Ld(ti) at time ti having a temporal variation and external light Ldark having no temporal variation. The external light Ld(ti) at time ti corresponds, for example, to the external light Ld (refer to FIG. 3) that enters through the gap between the housing 200 and the wrist. The external light Ldark having no temporal variation is a component of light that enters when the light sources 123 are off, excluding the external light Ld. Since the outer perimeter of the housing 200 is shielded from light in the present embodiment, the external light Ldark is negligibly weaker than the external light Ld(ti).

Lphoto(ti) in the second detection values Bp is the light entering the detection area AA1 when the light sources 123 are on, and includes incident light La and the external light Ld(ti) at time ti. The incident light La is light of the light Lp (refer to FIG. 2) emitted from the light sources 123 that is reflected by the human body HB and enters the optical sensors PD in the detection area AA1.

As illustrated in Expression (1), the detection data C1 is obtained by the differences between the first detection values Bd and the second detection values Bp. Therefore, the components of the detection values due to external light Ld(ti) at time ti are canceled. The effect of the external light Ldark having no temporal variation in the first detection values Bd is very small. Therefore, the detection data C1 is practically proportional to the incident light La entering the detection area AA1.

The detection data C2 of the detection area AA2 is expressed by Expression (2) given below.

C2=D×Lphoto(ti)−D×Ldark(ti)=D×(Lb+Ld(ti))−D×(Ld(ti)+Ldark)≈D×Lb (2)

Ldark(ti), Lphoto(ti), the external light Ld(ti), the external light Ldark, and the incident light Lb in Expression (2) are the same as those explained in Expression (1), and will not be explained again. As illustrated in Expression (2), the detection data C2 is substantially proportional to the incident light Lb entering the detection area AA2.

A contrast CRab between the two detection areas AA1 and AA2 is expressed by Expression (3) given below.

CRab=C1/C2=(D×La)/(D×Lb)=La/Lb (3)

As illustrated in Expression (3), even when the external light Ld(ti) varies over time, the contrast CRab between the two detection areas AA1 and AA2 has a stable high value because of not being affected by the external light Ld(ti).

In contrast, the following describes a comparative example in which the baseline data (first detection values Bd) is acquired when the light sources 123 are off at, for example, the start of the detection (for example, when the detection device 1 is turned on). In the comparison example, after acquiring the first detection values Bd at the start of detection, the second detection values Bp are repeatedly acquired from multiple optical sensors PD when the light source 123 is on in the multiple frame periods F.

In the comparative example, the detection data C1 in the detection area AA1 is expressed by Expression (4) given below.

C1=D×Lphoto(ti)−D×Ldark=D×(La+Ld(ti))−D×Ldark (4)

As illustrated in Expression (4), D×Lphoto(ti) corresponding to the second detection values Bp is the same as that illustrated in Expression (1) given above, and includes the component of the external light Ld(ti) at time ti. D×Ldark corresponding to the first detection values Bd is measured only once at the start of detection, and therefore, does not include the component of the external light Ld(ti) at time ti having a temporal variation, unlike Expression (1) given above. Therefore, as illustrated in Expression (4), the component of the external light Ld(ti) at time ti remains in the detection data C1 without being canceled.

In the comparative example, the detection data C2 in the detection area AA2 is expressed by Expression (5) given below.

C2=D×Lphoto(ti)−D×Ldark=D×(Lb+Ld(ti))−D×Ldark (5)

As illustrated in Expression (5), D×Lphoto(ti) corresponding to the second detection values Bp is the same as that illustrated in Expression (2) given above, and includes the component of the external light Ld(ti) at time ti. D×Ldark corresponding to the first detection values Bd does not include the component of the external light Ld(ti) at time ti having a temporal variation, in the same way as Expression (4) given above. Therefore, as illustrated in Expression (5), the component of the external light Ld(ti) at time ti remains in the detection data C2 without being canceled.

The contrast CRab between the two detection areas AA1 and AA2 in the comparative example is expressed by Expression (6) given below.

CRab=C1/C2=(D×(Lb+Ld(ti))−D ×Ldark)/(D×(Lb+Ld(ti))−D×Ldark) (6)

If Xa(Ti)=(Ld(ti)−Ldark)/La and Xb(Ti)=(Ld(ti)−Ldark)/Lb, Expression (6) can be expressed as Expression (7) given below.

CRab=(La/Lb)×(1+Xa(Ti))/(1+Xb(Ti)) (7)

As illustrated in Expressions (6) and (7), the contrast CRab in the comparative example may vary and become smaller over time due to the effect of the external light Ld(ti) at time ti.

As described above, the detection device 1 of the present embodiment is capable of inhibiting the reduction in contrast of the image. Expressions (1) to (7) are illustrated in a simplified manner for clarity of explanation. The calculation of the contrast CRab is not limited to these expressions.

While the preferred embodiment of the present disclosure has been described above, the present disclosure is not limited to the embodiment described above. The content disclosed in the embodiment is merely an example, and can be variously modified within the scope not departing from the gist of the present disclosure. Any modifications appropriately made within the scope not departing from the gist of the present disclosure also naturally belong to the technical scope of the present disclosure. At least one of various omissions, substitutions, and changes of the components can be made without departing from the gist of the embodiment and the modifications thereof described above.

What is claimed is:

1. A detection device comprising:
a ring-shaped housing;
a plurality of optical sensors and at least one light source that are provided on an inner peripheral surface side of the housing; and
a detection circuit that is coupled to the optical sensors and configured to acquire a detection value from each of the optical sensors, wherein
assuming a period in which the detection values are acquired from the optical sensors as a frame period,
the light source is configured to repeatedly turn on and off for each of the frame periods, and
a difference between a first detection value acquired when the light source is off and a second detection value acquired when the light source is on is acquired as detection data for each of the optical sensors in the adjacent frame periods.

2. The detection device according to claim 1, wherein
in a plurality of the frame periods from a start to an end of measurement of the optical sensors,
the light source is configured to repeatedly turn on and off for each of the frame periods, and
the detection data is repeatedly generated in each of the adjacent frame periods.

3. The detection device according to claim 1, comprising a power supply configured to supply a drive voltage or a drive current to the optical sensors, wherein
in a plurality of the frame periods from on to off of the power supply,
the light source is configured to be turned on and off repeatedly for each of the frame periods, and
the detection data is repeatedly generated in each of the adjacent frame periods.

4. The detection device according to claim 1, wherein the optical sensors are arranged at least two along a peripheral direction or a direction orthogonal to the peripheral direction of the housing.

5. The detection device according to claim 1, wherein the optical sensors are arranged in a planar configuration along a peripheral direction and a direction orthogonal to the peripheral direction of the housing.

6. The detection device according to claim 1, comprising a plurality of the light sources, wherein
a detection area in which the optical sensors are arranged is provided along a peripheral direction of the housing, and
the light sources are arranged at both ends in the peripheral direction of the detection area.

7. The detection device according to claim 1, wherein the ring-shaped housing is a wristband configured to be worn on a wrist.

8. The detection device according to claim 1, wherein the ring-shaped housing is a finger ring configured to be worn on a finger.
